(19) United States
(12) Patent Application Publication
(10) Pub. No.: US 2006/0282283 A1
(43) Pub. Date: Dec. 14, 2006

(54) Media network

(76) Inventor: Brian F. Monahan, Mill Valley, CA (US)

Correspondence Address: Thomas J. Monahan;Monahan & Costello, LLC., 4154 Madison Avenue, Trumbull, CT, 06611, US

(21) Appl. No.: 11/451,981

(22) Filed: Jun. 13, 2006

Related U.S. Application Data
(60) Provisional application No. 60/689,823, filed on Jun. 13, 2005.

(51) Int. Cl. G07G 1/14

(52) U.S. Cl. 705/1; 705/14; 705/10

(57) ABSTRACT

Advertising network system and method. A media network system and method is described. The media network system of the invention, identified herein as The Fast Twitch Media Network (“FTM”), provides a coordinated hub or network connecting artists, brands and audience aggregators. The interactive network system and method of the invention provides pay-per-performance compensation to independent artists that create brand-inspired user-generated media assets. The media assets are preferably short branded-entertainment videos delivered over the internet.

This application claims priority from U.S. Provisional Application No. 60/689,823 filed Jun. 13, 2005.

### BACKGROUND OF THE INVENTION

1. Field of the Invention

The present invention relates generally to a system and method of developing and distributing media products for advertising. More specifically, the invention relates in a preferred embodiment to a network (i.e., The Fast Twitch Media Network, “FTM”) that is a hub connecting artists, brands, and audience aggregators. FTM provides the economic infrastructure for brands to tap the creative talent of independent content creators whereby their compensation is directly tied to the popularity of the work they produce. FTM outputs pieces of media (videos, printed pages, billboards, web pages, etc.) that while not necessarily recognizable as overt advertisements; they were built for and approved by an underwriting Brand. Produced assets are then syndicated across a network of participating media outlets.

Fast Twitch provides an efficient way for Brands to harness creative talent that lies outside of the existing advertising and content producing profession. It does so in a flexible and automated where compensation is directly tied to performance.

2. Description of the Prior Art

One of the challenges of the diverse field of modern media is to provide brands with fresh communication ideas that can be efficiently distributed to scaled audiences. Brand owners not uncommonly hire advertising agencies with media departments to prepare advertisements. However, as audiences fragment into the ever increasing choice of media to consume and are empowered with technology to avoid exposure to standard ad units, Brands and their Agents are struggling to create enough variety and volume in their communications to resonate with increasingly niche audiences.

Brand owners work with a number of third party media entities to distribute their messages. Brands seek to minimize the financial risk of not having their ads noticed by increasingly weaving their product into the editorial content (e.g. product placement, presenting sponsorship, etc).

Typically the artists creating media assets and ads on behalf of brands generally receive hourly or fixed salaried compensation and do not provide pay-per-performance incentives tied to the success of the campaign defined by how often their work is viewed.

There is a need for a large volume of highly targeted standard ad units and customized entertaining media experiences in various formats that simultaneously communicate brand information. Furthermore, there is a need for an efficient way for Brands to distribute such works to a network of media entities that actually touch niche and scaled audiences.

Accordingly, it is an object of the present invention to provide a new and improved method of producing and managing brand-inspired user-generated media.

Another object of the present invention is to provide an integrated system and method that provides incentives and rewards for independent artists to create brand-inspired media.

These and other objects and advantages of the present invention and equivalents thereof, are achieved by the methods and systems of the present invention described herein and manifest in the appended claims.

### SUMMARY OF THE INVENTION

The present invention is directed to a novel method and system for producing and managing brand-inspired user-generated media. The method comprises assembling a plurality of independent content creators; assembling a plurality of brands marketers that each provide at least one description (Creative Brief) of a desired brand-inspired advertising media asset; assembling a network comprising a plurality of media properties; providing Creative Briefs to the independent content creators in an open audition soliciting the creation of user-generated brand-inspired media assets; obtaining brand marketer's approval of brand-inspired media assets provided by the independent content creators; distributing the approved brand-inspired media assets by said network of media properties; and providing compensation to the independent content creator(s) based upon a pay-per-performance schedule. The plurality of content creators, media properties and brand marketers is at least two, and is not limited by the total number of participants that may number in the thousands or even millions of participants.

The method of the invention is managed by a business entity (i.e., Fast Twtich Media ) primarily in an internet mediated automated system. The network of media properties is selected from the group of web sites, magazines, newspapers, TV stations/Networks, movie theatres, kiosks, ATM machines, and combinations thereof. Brand marketers provide a pay-per-performance monetization schedule with their Creative Briefs whereby Brands set their own value for exposure to any produced media assets. Brand-inspired media are selected from the group of videos, movies, music files, podcasts, images, websites, stories, articles, online banner advertisements, and combinations thereof. Brand-inspired user-generated media are preferably branded entertainments.

The present invention also provides a system for producing brand-inspired user-generated media assets that has a plurality of brand marketers having Creative Briefs directed toward desired brand-inspired user-generated media assets; a plurality of independent content creators having the capability of producing brand-inspired user-generated media assets of the Creative Briefs; a plurality of media properties having the capability of distributing brand-inspired user-generated media assets of the Creative Briefs; an internet based open audition of the independent content creators soliciting preparation of the brand-inspired user-generated media assets of the Creative Briefs; compensation means on a pay-per-performance basis for the brand-inspired user-generated media assets provided by the content creators in response to the open audition; and an internet website communication system linking the independent content creators, the brand marketers, and the media properties. In the system of the invention, the network of media properties is selected from the group of web sites, magazines, newspapers, TV stations/Networks, movie theatres, kiosks, ATM machines, and combinations thereof. The Creative Briefs of the brand marketers have pay-per-performance monetization schedules. Also, the brand-inspired media of the system of the invention are selected from the group of videos, movies, music files, podcasts, images, websites, stories, articles, online banner advertisements, and combinations thereof. The brand-inspired user-generated media of the system are preferably branded entertainments and preferably internet videos.

The present invention discloses an interactive web-based network comprising: a communication platform; and network members selected from the group of: a plurality of brand marketers, a network manager member; a plurality of independent media creators, and a plurality of media property members; an open audition means for said independent media creator members means offering a plurality of Creative Briefs of the brand marketer members as candidates for brand-inspired user-generated media; and brand-inspired user-generated media created by the independent media creator members based upon the Creative Briefs of the brand marketer members, wherein upon approval of the brand marketer members, the media are provided to the media property members for distribution; and compensation means on a pay-for-performance basis for the network manager member; the independent content creator members, and the media property members. The brand-inspired user-generated media of the network of the invention are selected from the group of videos, movies, music files, podcasts, images, websites, stories, articles, online banner advertisements, and combinations thereof. The brand-inspired user-generated media of the network of the invention are preferably branded-entertainment, videos delivered by the Internet. The media property members of the invention network have media means selected from the group of web sites, magazines, newspapers, TV stations/Networks, movie theatres, kiosks, ATM machines, and combinations thereof. The rate of the compensation means of the network is preferably set by the brand marketers. It can be seen that the present invention provides a unified essentially turn-key creation and distribution of media works for brands. The system of the invention is automated for site owners; also, assets are classified so that they appear on the most relevant sites.

Unless otherwise defined, all technical and scientific terms used herein have the same meaning as commonly understood by one of ordinary skill in the art to which this invention belongs. Although method and materials similar or equivalent to those descried herein can be used in the practice or testing of the present invention, preferred methods and materials are described below. Al publications, patent applications and other references mentioned herein are incorporated by reference in their entirety. In the case of conflict, the present specification, including definitions, will control. In addition, the materials, methods and examples are illustrative only and not intended to be limiting.

Other features and advantages of the present invention will be apparent from the following detailed description, and from the claims.

### BRIEF DESCRIPTION OF THE DRAWINGS

FIG. 1 is a schematic drawing of a Fast Twitch Media Network.

FIG. 2 is a schematic drawing of a creator referral affiliate program

FIG. 3 is a schematic representation of a Fast Twitch Media web site information architecture.

FIG. 4 is a schematic representation of a Fast Twitch Media web site technical architecture.

FIG. 5. is a Fast Twitch Media transaction flow chart.

### DETAILED DESCRIPTION OF THE INVENTION

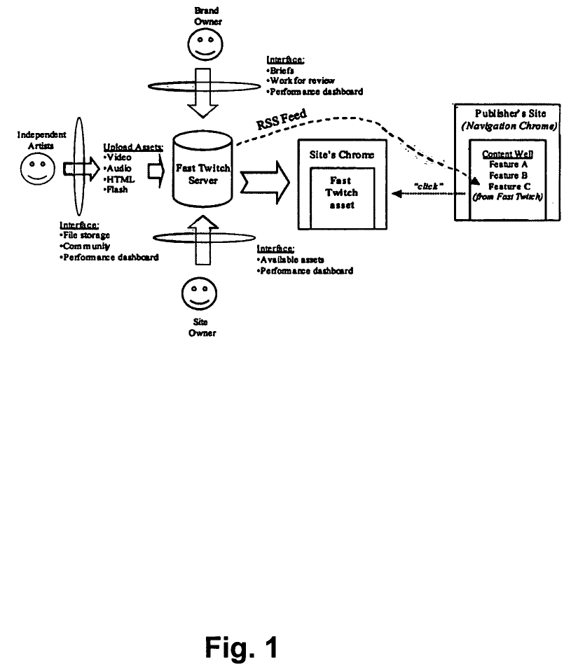

Referring now to FIG. 1, there is shown a schematic representation of a Fast Twitch Media Network. The drawing shows the interaction of independent artists, brand owners, and site owners.

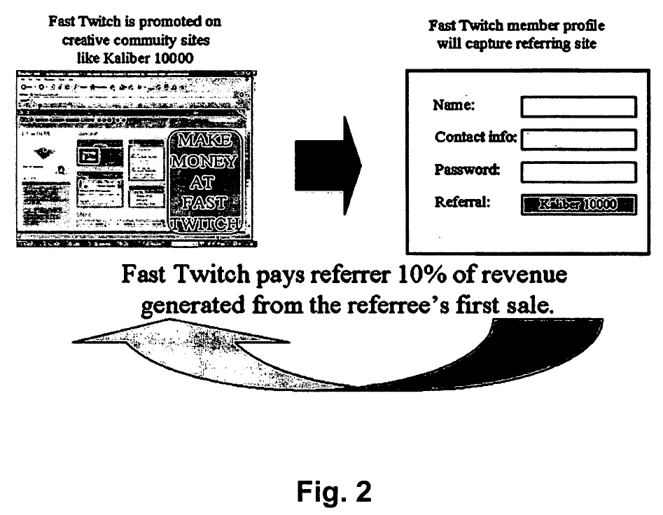

Referring now to FIG. 2, there is shown a schematic drawing of Fast Twitch Media referral program that shows a process whereby web sites that motivate content creators to click over to Fast Twitch are compensated for that referral. Referrals to Fast Twitch are not limited to web site referrals, but may come from any convenient source (i.e., print media; trade shows, etc.).

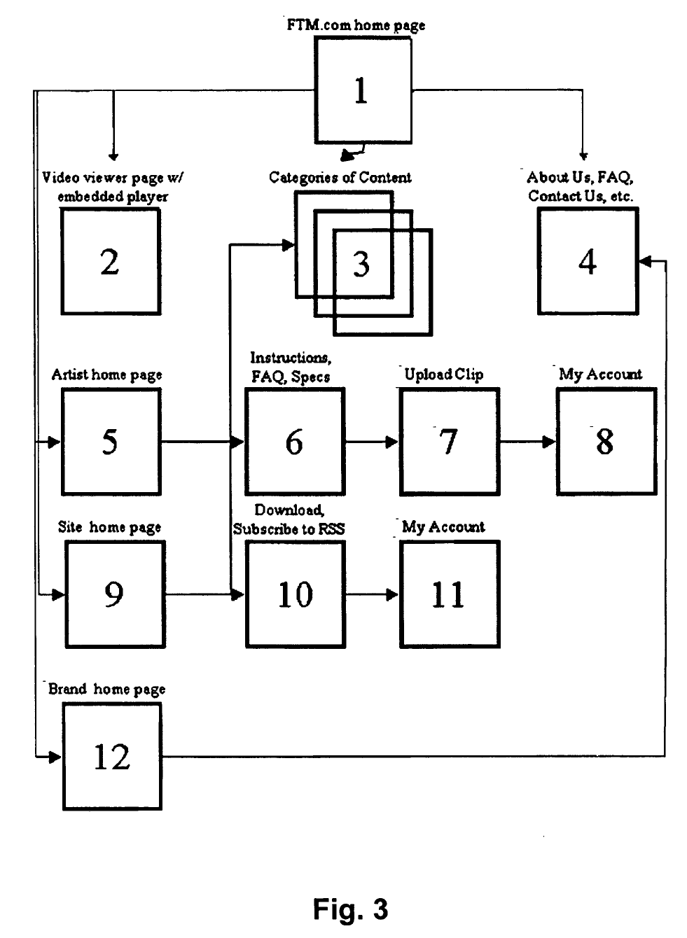

Referring now to FIG. 3, shown is a representative schematic representing information architecture of a Fast Twitch Media Network web site.

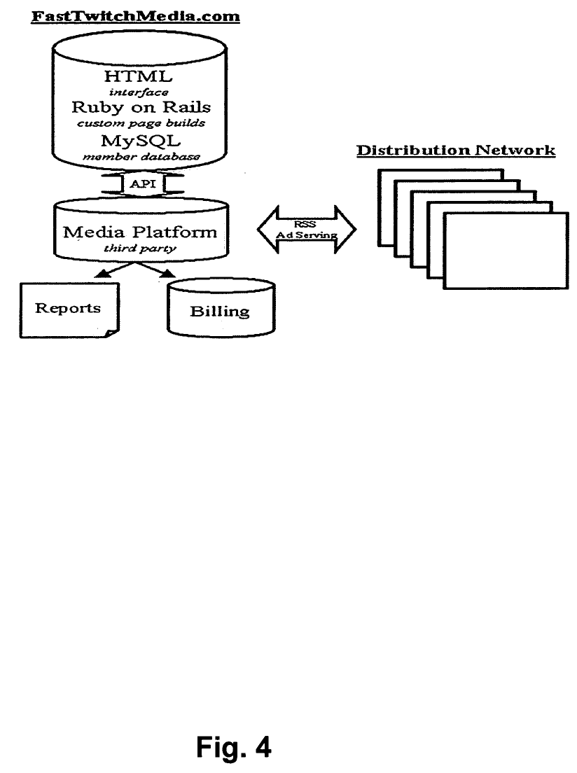

Referring now to FIG. 4, shown is representative schematic of the technical architecture of a Fast Twitch Media Network web site with a third party media platform.

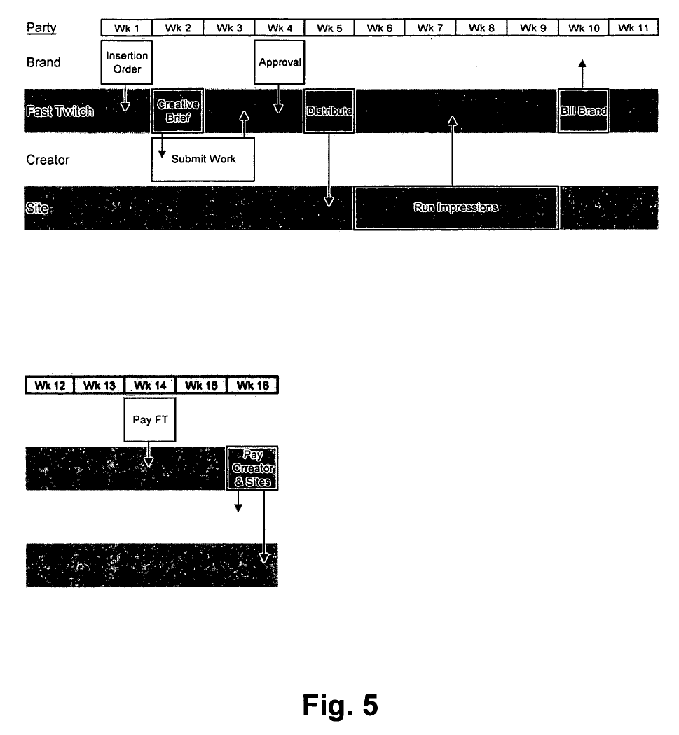

Referring now to FIG. 5, shown is a Fast Twitch Media Network flow chart that shows an approximate timeline with Fast Twitch Media coordinated interactions involving, brands, artists/creators, and a media site.

The Clients. By way of background, in the accelerated and fragmented modern media landscape, Brands are looking for fresh communication ideas from multiple sources. FTM sales people will solicit brand marketers or their Agents. The primary buyers of FTM services are likely to reside within Advertising Agency media departments. FTM will represent itself to media buyers as a pay per performance interactive advertising network. Most existing online pay-per-performance networks (e.g. ValueClick, Advertising.com, FastClick, etc.) broker unsold standard display ad unit inventory (e.g. 468×60 banners). The FTM network will allow Brands to define what type of assets they wish to distribute—be it standard display ads or short (<3 minute) video clips. This content will hold audience attention as if it were stand alone editorial content, however the primary message and overt sponsor attribution will be in line with the underwriting brand. Some will label this content as “branded entertainment.” FTM will not discourage that notion but we will primarily represent the product as a “sponsorship” as there are fewer sales hurdles to this more familiar media model. A “sponsorship” also presents fewer objections to being promoted to audiences as editorial content.

Brand marketers have messages they seek to communicate about their brand. FTM sales people will obtain an overview of what those messages are. This information will be compiled in a templatized “Creative Brief”. Alternatively, Brand Marketers can go to the FTM website and submit their “Creative Brief” without going through a sales person. In addition to defining what they seek to communicate about the brand, the Creative Brief will contain a description of the targeted audience for the communication. The Creative Brief will also state the method of communication the Brand is interested in. This “content” could include but is not limited to the following formats:
Short movies (5 seconds in duration and up)
Animated shorts (video files)
Music files (jingles, singing, mixes, mash ups)
Podcasts (audio files with a mix of spoken word and music)
Images (of any size, possibly capable of insertion in magazines/newspapers, posters, signs, screensavers)
Websites
Stories/articles
Online “banner” ads (of any size or rich media technology)

Regardless of format, the content will be quick hitting and of limited duration. The sponsoring brand will be hard coded into the content and the overall message of the content will be in alignment with the Brand's communication goals.

Participating Brands will also be able to submit digital assets along with the Brief (logo files, audio signatures, images, etc.). Guidelines will be provided as to how these brand assets can be used. The Brief will also include executional details like flight dates.

Brands not only dictate what they want the media asset to be about, they also dictate from the outset the value of an impression to those assets. When posting the Brief, Brands will state what an exposure to the desired message is worth to them. The value may change depending on form factor (e.g. 3 minute videos are worth more than a 5 minute podcast). For comparison, market rates for “traditional” interactive units are listed below:
Visit to a brand's web site:$2.00
Dedicated email: $0.15
:15 Streaming video ad: $0.03
Display ad: $0.01

Brands can choose to attract top creative FTM members by offering premium values per exposure. FTM's efforts to increase valuation of exposure to custom sponsorships are detailed below.

FTM will maintain a profile on participating Brand Marketers. This profile will include details about the company, information on past campaigns run through FTM (what they approved, the value per exposure, how much spent) as well as commentary from Artists that worked with them in the past. This profile will help Artists determine if they want to pursue the assignment.

In order to get access to an assignment, a participating content creator will need to agree to FTM's terms which stipulate no work can be released to the public without first obtaining the approval of the underwriting brand. This review process protects the Brand from unsavory commentary and provides an opportunity to address any copyright violations in submitted works.

The Talent. Advances in software, hardware, bandwidth, and computer skill levels have created an “army” of amateur content creators. According to the Pew Internet & American Life Project, 8.4 million US web users have created a blog or web-based diary.

FTM will cultivate a community of digital artists capable of producing the types of media described above. These artists will not be employed by FTM. They will work off-site at locations of their choice. Artists will be recruited through art schools and PR efforts.

The Creative Briefs of participating brands will be provided to these artists. If the artists see an opportunity that inspires them, and the amount the Brand is willing to pay per exposure motivates them, the artists will produce the work. Artists assume the risk and produce work with no guarantee the Brand will select it. Artists will have the option to submit ideas that are not fully produced, however that may diminish the likelihood of Brand selection. Artist-produced work will be posted for the Brand to review. The Brand then decides which pieces of media they want to distribute to target audiences. Brand Marketers will be able to contact Artists directly should they want revisions made to pieces of work. FTM and the Artist will jointly retain rights to work sourced through the hub. With risk limited by the pay per performance model described below, Brands will be encouraged to “pick up” multiple pieces of content and then whittle down based on actual results.

The artists assume the risk that they will waste their time creating content that does not get picked up by the brand. In return, however, they will be incentivized by a large pay out should their work get selected by the brand and then prove to be a popular with audience owners. Artists stand to make much more in this pay per performance model than if they were to charge an hourly wage in the dedicated service of the Brand. Many of the participating Artists would never have the opportunity to pitch commercial work to Brands were it not for FTM.

In addition to providing Artists a revenue generating opportunity, FTM will provide services that will appeal to the Artists. These services will include, but are not limited to:
Discounted software for media development
Free storage for media files
Asset library
Tutorials/instructions
Networking via directory by area of specialty and forums
Access to movie studios, SAG, professional agents, ad agencies and other types of professional content developers.

FTM will communicate with Artists through a special section of the website and via email newsletters. Artists will build an FTM profile that will link to all the work they have submitted and show which pieces were selected by Brands for distribution. Community will be fostered by allowing Artists to view all produced work made available for Brand Marketers to choose from. Artists will be encouraged to post comments and rate the work submitted to Brand Marketers. This commentary will be visible to all and can help Brand Marketers decide which pieces of content to select. FTM will make it easy for Artists to communicate with one another so they can share ideas and collaborate. This is consistent with the “open source” nature of creative development embodied in the FTM premise. Artists will earn points within the Fast Twitch system each time they sell some work or contribute to another members' sale. Members with higher status will be given access to incremental revenue generating opportunities.

At the end of the day, FTM's mission is to help Artists become famous. We will promote them accordingly. The unsung moonlighting high school math teacher who suddenly sells some work to a major brand is the FTM hero. Providing an outlet for people to pursue the dream of making a living off their creative expression will fuel FTM's talent pool.

In the event of successful match of Artist and Brand, FTM will not stand in the way of that relationship blossoming outside of FTM. We will however seek to offer added value services to the Artists for things such as contract negotiation and continued use of the FTM “digital studio.”

The Audience. FTM's quick nuggets of entertaining content will satisfy the growing need for fresh material of the ever-expanding universe of media brands.

Once Brand Clients have selected their pieces of content, FTM will then syndicate that content to a participating network of media properties. These media properties could include but are not limited to:
Web sites
Magazines
Newspapers
TV Stations/Networks
Radio Stations/Networks
Movie theatres
Kiosks/ATM machines

It is largely expected that at launch most of the participating media properties will be web sites.

FTM staff will solicit media properties to participate in the network. Alternatively, media property owners can come to the FTM web site and sign up themselves. For comparison, the ValueClick network claims 14,000 participating web sites world wide.

When media properties sign up for the network they will specify the types of content they can run (i.e. streaming radio stations can specify the type of audio file needed).

When content is approved by a Client for distribution, media owners who can take that content will be notified and exposed to the work. They will also be shown what the Client is willing to pay per exposure. If the media owner feels the content fits with their property and is motivated by the amount the Client is willing to pay, they will pick up the content and run it. Media properties can manually log in to Fast Twitch's servers to get a copy of the material. Web based media companies will have the option of automatically displaying FTM output via an RSS feed or display ad server.

In the current pay-per-performance standard ad unit model, site owners typically earn 50% of a $1.50 effective CPM (cost per exposure of $0.0015). By selling higher value ad impressions, FTM will be able to pay sites almost 100x that going rate per exposure. Most importantly, FTM syndicated sponsorships do not cannibalize a publisher's display ad or text link (a.k.a. Google AdSense) inventory. For online content, FTM will use its own ad server to count exposure. These counts will be the basis for financial compensation.

All content will be branded as Fast Twitch Media. In addition to syndicated content, FTM content will run on a proprietary consumer property at www.fasttwitchmedia.com. Traffic to this site will be built through PR and search engine marketing. The fast hitting FTM content will be particularly suited for display on devices other than PCs. In addition to the web site, beachheads will be pursued alternate platforms such as the Windows Media Center or Verizon Vcast. Ultimately, Fast Twitch should become its own media brand with a signature blend of quirky, short attention span, products/pieces of content.

The Business. Participating Brand Marketers will set what they are willing to pay for exposure to a piece of branded content. They will be able to cap maximum financial liability. Once the maximum out of pocket has been met their content will be removed from the distribution. The ceiling will be disclosed to the artists and the media properties and will influence the “take rate” on the assignment.

Revenue will be split between FTM, the artist, and the media property. For example, if exposure to a piece of content costs a participating Brand Marketer $0.60, and revenue is being split evenly, each party will be paid $0.20. If that piece of content is shown 100,000 times, each party will make $20,000.

The other key to maximizing revenue will be justifying higher exposure values. At bare minimum, FTM should be able to charge rates equivalent to a streaming video ad ($0.03). With some strong initial case studies, we anticipate being able to very quickly increase cost per exposures to the equivalent of a direct mail delivery ($0.15). We believe the richness of the experience will offset the lack of targeting that comes from the open syndication model. A single exposure to an FTM sponsorship will be determined at the unique user level. Multiple page views or ad impressions generated during that user's exposure will help support the increased value per touch. Additionally, the value of an FTM exposure is a “fully” loaded cost that includes creative development. Existing media models do not factor in creative development costs into the media efficiency analysis. These hard costs can raise the true cost to an advertiser of an ad buy as much as 25%.

Research will need to be commissioned that shows that recall lifts of exposure to “branded entertainments” are closer to the lifts generated by a visit to a Brand's web site as opposed to exposure to a standard banner ad. For every participating brand, a small sample of the target will need to be surveyed after exposure to the brand's site, a typical banner ad for the brand, and the selected FTM content. In that way a benchmark database will be built. This tool will be made available to the Brands when they establish the value per exposure to their content.

It will also need to be demonstrated that higher bids per exposure will benefit the Brand Marketer in terms of the quality of the content that is built for them and the scale to which it gets distributed. Benchmarks showing historical volume by exposure value will be provided to the Brand when they are establishing their FTM value.

While we don't anticipate being able to charge the full value of a visit to a Brand's web site we do believe that the body of results evidence combined with the demonstrated lift in distribution of higher exposure values will allow us to get average pricing per exposure in the $0.30 range.

The core offering will encompass the content creation and distribution. However, alternative pricing models will be developed for pure content generation. A rate card will be developed should a Brand simply want to buy and idea outright and then run it on their own. Brands can also use Fast Twitch for creative tasks that do not require originating brand new ideas—for example repurposing an existing ad into a different size and shape.

This model need not only apply to Brands. Tapping the network to make personal “reels” for online dating sites could be a niche market. Alternatively, a Brand may bring FTM a fully developed custom sponsorship which could then be pushed out to the network. In that case, the value per exposure will be split 50/50 between FTM and the publisher.

International. FTM should be able to operate in any country as easily as it does in the US. Artists can reside anywhere. Sites can join the network from any country. The initial roll out will be in the US to take advantage of the relatively developed US ad market. However, based on interest level, other in-language versions of the site can follow.

Rationale. A proliferation of digital media capture devices (cameras, recorders) and easier to use software, advanced computing skills, ubiquitous broadband and storage are democratizing content creation. “Amateurs” are producing compelling pieces of content that audiences want to watch. FTM allows these amateurs, hobbyists, and moonlighters to earn income while building their portfolio of work.

Fragmenting media consumption has media properties constantly searching for fresh content that will hold their audiences. Additionally, increased competition for ad dollars has them seeking new revenue sources as well. FTM provides them with a turn key content and revenue that does not cannibalize any other revenue streams.

Brands are looking for fresh ways to connect with their target audiences in a way that mitigates risk. FTM provides them access to many new ideas without the significant expense typically associated with content generation. The pay per exposure model limits their risk. Positioning these opportunities as “sponsorships” allows the media buyers to authorize the buy without engaging the institutional brand stakeholders such as Agency Creative Directors who have a selfish interest in maintaining control of developing branded ads and content.

The ad market has never been more ready to embrace the new FTM advertising model. Online media is ascendant and Brands are demanding new approaches. FTM's leverages the strength of the network to build a scaleable model that provides incentive for all sides.

Although the present invention describes in detail certain embodiments, it is understood that variation and modifications exist known to those skilled in the art that are within the invention. Accordingly, the present invention is intended to encompass all such alternatives, modifications and variation that are within the scope of the invention as set forth in the following claims.

What is claimed is:

1. A method for producing and managing brand-inspired user-generated media comprising:
assembling a plurality of independent content creators;
assembling a plurality of brands marketers that each provide at least one description (Creative Brief) of a desired brand-inspired advertising media asset;
assembling a network comprising a plurality of media properties;
providing Creative Briefs to said independent content creators in an open audition soliciting the creation of user-generated brand-inspired media assets;
obtaining brand marketer's approval of brand-inspired media assets provided by said independent content creators;
distributing said approved brand-inspired media assets by said network of media properties; and
providing compensation to said independent content creator based upon a pay-per-performance schedule.

2. The method of claim 1, wherein said method steps are managed by a business entity primarily in an internet mediated automated system.

3. The method of claim 1, wherein said network of media properties is selected from the group of web sites, magazines, newspapers, TV stations/Networks, movie theatres, kiosks, ATM machines, and combinations thereof.

4. The method of claim 1, wherein said brand marketers provide a pay-per-performance monetization schedule with said Creative Brief whereby Brands set their own value for exposure to any produced media assets.

5. The method of claim 1, wherein said brand-inspired media are selected from the group of videos, movies, music files, podcasts, images, websites, stories, articles, online banner advertisements, and combinations thereof.

6. The method of claim 1, wherein said brand-inspired user-generated media are branded entertainments.

7. A system for producing brand-inspired user-generated media assets comprising:
a plurality of brand marketers having Creative Briefs directed toward desired brand-inspired user-generated media assets;
a plurality of independent content creators having the capability of producing brand-inspired user-generated media assets of said Creative Briefs;
a plurality of media properties having the capability of distributing brand-inspired user-generated media assets of said Creative Briefs;
an internet based open audition of said independent content creators soliciting preparation of said brand-inspired user-generated media assets of said Creative Briefs;
compensation means on a pay-per-performance basis for said brand-inspired user-generated media assets provided by said content creators in response to said audition; and
an internet website communication system linking said independent content creators, said brand marketers, and said media properties.

8. The system of claim 7, wherein said network of media properties is selected from the group of web sites, magazines, newspapers, TV stations/Networks, movie theatres, kiosks, ATM machines, and combinations thereof.

9. The system of claim 7, wherein said Creative Briefs of said brand marketers have pay-per-performance monetization schedules.

10. The system of claim 7, wherein said brand-inspired media are selected from the group of videos, movies, music files, podcasts, images, websites, stories, articles, online banner advertisements, and combinations thereof.

11. The system of claim 7, wherein said brand-inspired user-generated media are branded entertainments.

12. An interactive web-based network comprising:
a communication platform; and
network members selected from the group of: a plurality of brand marketers, a network manager member; a plurality of independent media creators, and a plurality of media property members;
an open audition means for said independent media creator members means offering a plurality of Creative Briefs of said brand marketer members as candidates for brand-inspired user-generated media; and
brand-inspired user-generated media created by said independent media creator members based upon said Creative Briefs of said brand marketer members, wherein upon approval of said brand marketer members, said media are provided to said media property members for distribution; and
compensation means on a pay-for-performance basis for said network manager member; said independent content creator members, and said media property members.

13. The network of claim 12, wherein said brand-inspired user-generated media are selected from the group of videos, movies, music files, podcasts, images, websites, stories, articles, online banner advertisements, and combinations thereof.

14. The network of claim 12, wherein said brand-inspired user-generated media are branded-entertainment videos delivered by the Internet.

15. The network of claim 12, wherein said media property members have media means selected from the group of web sites, magazines, newspapers, TV stations/Networks, movie theatres, kiosks, ATM machines, and combinations thereof.

16. The network of claim 12, wherein the rate of said compensation means is set by said brand marketers.

17. The network of claim 12 that provides turn-key creation and distribution of brand-inspired media, automation and asset classification for media property web sites.
